(19) United States
(12) Patent Application Publication
(10) Pub. No.: US 2011/0112956 A1
(43) Pub. Date: May 12, 2011

(54) CREDIT FACILITIES MANAGER

(76) Inventors: Con Way Ling, New York, NY (US); Christopher Robert Martin Stanton, Bellevue, WA (US)

(21) Appl. No.: 12/940,921

(22) Filed: Nov. 5, 2010

Related U.S. Application Data
(60) Provisional application No. 61/258,774, filed on Nov. 6, 2009.

(51) Int. Cl. G06Q 40/00

(52) U.S. Cl. 705/38

(57) ABSTRACT

The present invention provides computerized mechanisms for managing credit facilities. In one embodiment, computerized mechanisms coordinate and control communications between three types of entities that enable one entity to fund activity between a borrower and a lender. In another embodiment, the computerized mechanisms provide additional features to match each of the entities. In addition, other embodiments provide management mechanisms for managing the relationships between the entities that interface through their respective tools.

### CROSS-REFERENCES TO RELATED APPLICATION

This application is a non-provisional of and claims priority to Provisional U.S. Patent Application No. 61/258,774, entitled, “METHOD FOR DIRECTLY MATCHING FUNDING ENTITIES TO BORROWING ENTITIES FOR REVOLVING CREDIT,” filed on Nov. 6, 2009, by Con Way Ling, which said application is incorporated herein in its entirety for all purposes.

### BACKGROUND

Notwithstanding the tools currently available to lenders and borrowers, it continues to be difficult for consumers to obtain credit and for financial institutions to identify partners and reliable credit consumers. New systems for identifying reliable business partnerships and managing relationships between business entities are needed. It is with respect to these considerations and others that the disclosure made herein is presented.

### SUMMARY

The present invention provides computerized mechanisms for managing credit facilities. In one embodiment, computerized mechanisms coordinate and control communications between three types of entities that enable one entity to fund activity between a borrower and a lender. The coordination and control mechanisms provide a means for associating funds or other assets to facilitate lending activity by a lender. In another embodiment, the computerized mechanisms provide additional features to match each of the entities. In addition, other embodiments provide management mechanisms for managing the relationships between the entities that interface through their respective tools.

In one embodiment, the invention provides mechanisms for coordinating and controlling communications between a Funder, Borrower and Lender to facilitate lending activity between Lender and Borrower. Funder information, Borrower information and Lender information are stored in a database. The information from the Funder, Lender and/or Borrower is processed to formulate the parameters for the relationship among Lender, Borrower and Funder. Aspects of the invention capture and store agreements between any or all of Funder, Borrower and Lender. Aspects of the invention verify that the Funder is in compliance with Lender terms, verifies association of funds and transmits to Lender verification status. The Lender initiates credit activity with Borrower based on verification status. Configurations of the invention allow for Lender to be the same or a separate entity from a Deposit Holder. The Deposit Holder holds the funds or other assets associated by Funder.

In another embodiment the invention provides mechanisms for matching two or more of Funder, Borrower and Lender, so that Funder facilitates lending activity between a Lender and the matched Borrower. Funder information, Borrower information and Lender information are stored in a database. Aspects of the invention use tools known to those ordinarily skilled in the art to obtain and store in the database additional information on Borrower including but not limited to personal information, data about credit history from credit bureaus, credit scores such as the FICO score and/or other scoring and ranking data. Matching may occur by mutual entity selection without filtering, entity selection after applying filtering criteria specified by one or more entities and/or optimization criteria, or by auction or bidding process in conjunction with or without application of filtering criteria. Another configuration of the invention provides a mechanism for matching, in addition, to the entities described above, a Deposit Holder in which case Deposit Holder information would also be stored in the database and used to match the Deposit Holder with one or more other entities.

In yet another embodiment, the invention provides mechanisms for managing relationships between Funders, Lenders and Borrowers. Funder information, Lender information and Borrower information are stored in a database. Processes of the present invention utilize predetermined parameters to formulate the terms under which lending activity will occur. The results of the formulation are submitted to a management system, which ensures borrower usage is managed within the formulated lending activity terms. The management system may process and store information related to borrower usage. The management system may also obtain information related to borrower usage from an external processing system. The management system tracks and reports borrower usage information. Funder and Lender may adjust Funder and Lender terms or other information periodically in the ordinary course or in response to borrower usage information. These adjustments may be based on programmed criteria or directed through periodic inputs by Funder or Lender. The management system may also be used to terminate relationships and/or identify the need for new entity matching. Another configuration of the invention provides a mechanism for managing, in addition to the relationships with the entities discussed above, the relationship with a Deposit Holder in which case Deposit Holder information would also be stored in the database and used in connection with management of changes to the deposit by Funder and foreclosure or execution on the deposit by Lender.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram illustrating one embodiment of a control system.

FIG. 2 is a block flow diagram of one embodiment of a control process used in conjunction with the system illustrated in FIG. 1.

FIG. 3 is a block diagram illustrating one embodiment of a matching system.

FIG. 4 is a block diagram illustrating one embodiment of a management system.

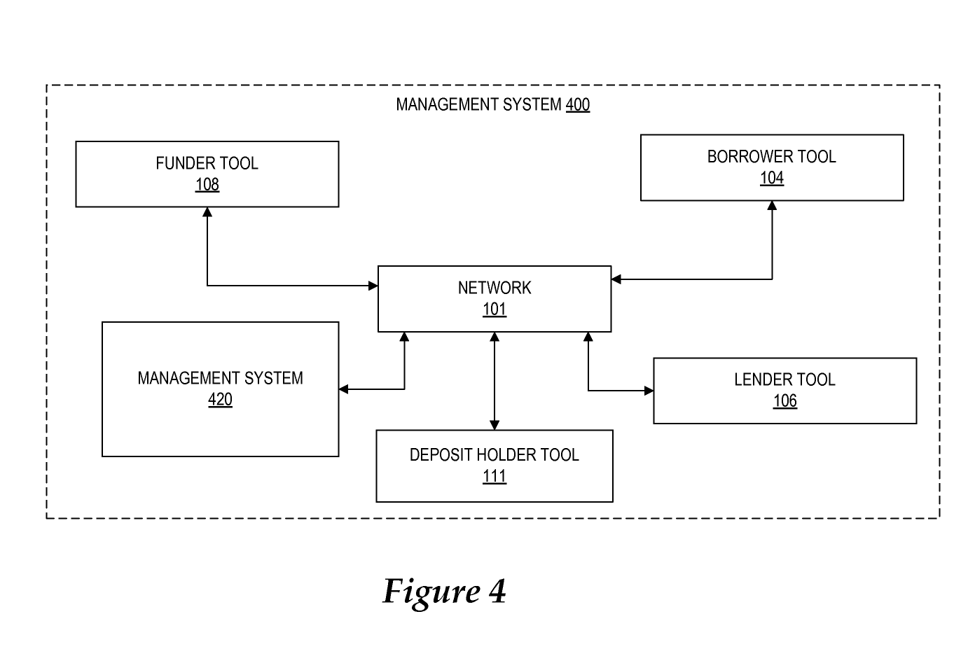

FIG. 5 is a block flow diagram of a control, matching and management process.

FIG. 6 is a computer architecture diagram showing an illustrative computer hardware architecture for a computing system capable of implementing the embodiments presented herein.

### DETAILED DESCRIPTION

The present invention provides computerized mechanisms for managing credit facilities. In one embodiment, computerized mechanisms coordinate and control communications between three types of entities that enable a Funder to fund activity between a Borrower and a Lender. The coordination and control mechanisms provide a means for associating funds or other assets to facilitate lending activity between Lender and Borrower. In another embodiment, the computerized mechanisms provide additional features to match each of the entities. In addition, other embodiments provide management mechanisms for managing the relationships between the entities that interface through their respective tools.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and which are shown by way of illustration, specific embodiments, or examples. Referring now to the drawings, in which like numerals represent like elements through the several figures, a computing system and methodology for providing communication and coordination between web services in a cloud-based computing environment will be described. The present invention provides, in addition to other mechanisms, a coordination and control process, a matching process, a funding and payment process and a termination process. Each aspect of the present invention can be used independently, or in conjunction with each other, or in any combination in part or in whole.

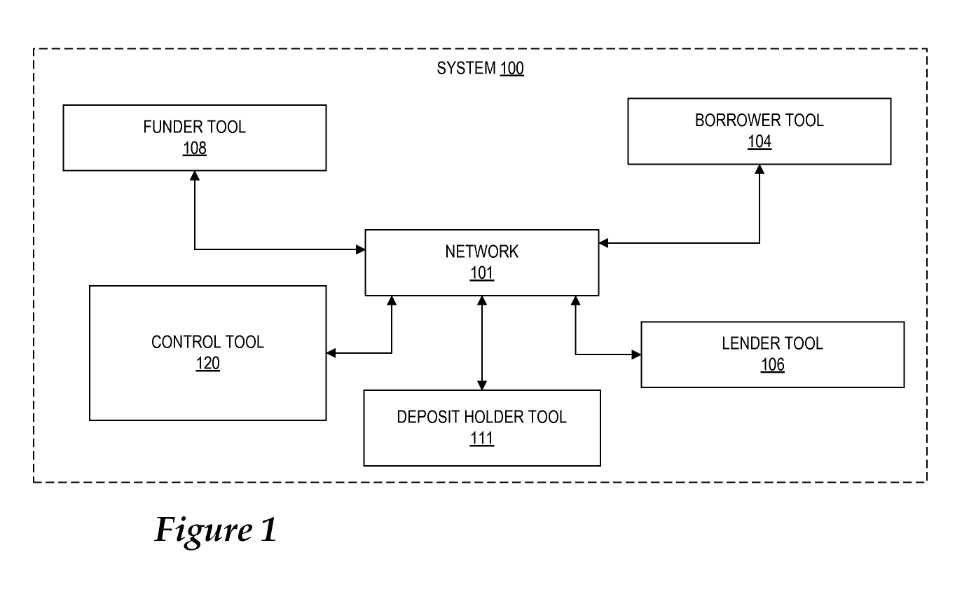

For purposes of illustrating aspects of invention, a Lender can be a bank, financial institution or other person or entity that functions to provide loans, credit cards, lines of credit or other term or revolving credit facilities. A Borrower or borrowing entities could be a person or entity seeking credit or funds in the form of a loan, credit card, line of credit or other term or revolving credit facility. A Funder can be any entity that provides funds or other assets for purposes of facilitating lending activity between Lender and Borrower. For illustrative purposes, the Funder can be a bank, financial institution, pension fund, investment fund, person or other entity. A Deposit Holder can be the same entity as the Lender or can be a separate entity. In the case where Deposit Holder is a separate entity, it can be a bank, financial institution or other person or entity that serves as a repository for the funds or other assets associated by Funder. Referring now to FIG. 1, aspects of the present invention are now described. In one embodiment, the system 100 comprises a Network 101, a Borrower Tool 104, a Funder Tool 108, a Lender Tool 106, a Deposit Holder Tool 111 and a Control Tool 113.

A borrower can access the system 100 through the Borrower Tool 104 by the use of commonly available means, such as a computer, mobile device, or any like device, which may include, but not limited to, a web-based application. Borrower Tool 104 includes a user interface that allows borrowers to sign up and enter information. The information captured at sign up is information used by methods known to one of ordinary skill in the art including but is not limited to personally identifiable information, borrowing needs, acknowledgement of regulatory disclosures and acceptance of a combination of selected terms. The Borrower Tool 104 may also include computerized mechanisms that allow borrowers to manage their application and account to review and provide information typically managed and accessed by methods known to one of ordinary skill in the art including but not limited to application status, credit bureau data, credit scores, custom scoring results, account information, Funder information, historic performance and budgeting details.

Funding entities can access the system 100 through the Funder Tool 106 by the use of commonly available means, such as a computer, mobile device, or any like device, which may include, but not limited to, a web-based application. The Funder Tool 106 provides computerized mechanisms that allow funders to sign up and enter information. The information captured at sign up is information used by methods known to one of ordinary skill in the art including but not limited to personally identifiable information, funding terms, acknowledgement of any regulatory disclosures and acceptance of a combination of selected terms. Funders may use the Funder Tool 106 to manage their account and accesses account information typically managed and accessed by methods known to one of ordinary skill in the art including but not limited to balance information, Borrower information, Funder portfolio information, withdrawal options, deposit options, historic performance, gain or loss information and budgeting details.

The Lender Tool 106 allows the Lender to input information about loan product type and loan product terms. Examples of loan product types include: credit card, home equity line, personal line etc. Examples of loan product terms include minimum and maximum credit limit, Borrower requirements in terms of credit bureau data, credit score, Funder requirements in terms of the type of assets that may be associated and terms of association, interest rate, fees, default procedures, required disclosures, program administration procedures, collections methods, customer service and support instructions, etc. Other terms may define how the associated asset may be held, e.g., escrow, deposit account, etc. Lenders may also use the Lender Tool to manage accounts and access account information typically managed and accessed by methods known to one of ordinary skill in the art including but limited to account activity, payment activity, defaults, collection activity and portfolio characteristics.

In some configurations of the invention, there may also be a Deposit Holder Tool 111 that allows the Deposit Holder, whether Lender or a separate entity, to input information about the types of assets that the Deposit Holder will hold and the terms under which those assets will be held, including without limitation, interest rates that may be paid on assets deposited with Deposit Holder and any fees that may be charged by Deposit Holder.

The Control Tool 120 is configured to obtain and store information related to the Borrower Tool 104, the Funder Tool 108 and the Lender Tool 106. The Control Tool 120 may also communicate processed results to the Borrower Tool 104, the Funder Tool 108, and the Lender Tool 106. In some configurations the Control Tool 120 also obtains, stores and communicates information and processed results related to the Deposit Holder Tool 111. In the illustrative examples below, the communicated information includes lending terms, personally identifiable information, Borrower credit score or other credit history data, data about the associated asset, associated asset access details, acknowledgement of agreements. The role of the Control Tool 120 is to establish the relationships between the Funder, Borrower and Lender and, if different from Lender, Deposit Holder. The Control Tool 120 coordinates and controls communications among one or more Funders, Borrowers, Lenders and Deposit Holders.

An illustrative example using the system 100 involves a scenario where a parent, a Funder, wants to assist a daughter, a Borrower, to obtain a credit card with a lending entity, which may be a bank, a credit card issuer or any other like entity. As described in detail below, unique features of the present invention allow the Borrower to obtain a credit card even if the Borrower has a credit status that would not normally allow her to obtain a loan. Other unique aspects of the invention allow a Funder, in this example, the parent, to provide funds to facilitate the issued credit, where the funds are provided by non-invasive mechanisms that do not require an actual transfer of the funds to either the Lender or the Borrower. Among many other benefits, the Funder may retain the funds and thereby simplify tax consequences, allocation of interest earned on the funds, etc. Additional unique aspects of the invention allow a Lender to extend a loan without incurring risk of credit loss. Among many other benefits, the Lender may earn fees and interest from their lending infrastructure without impacting capital requirements.

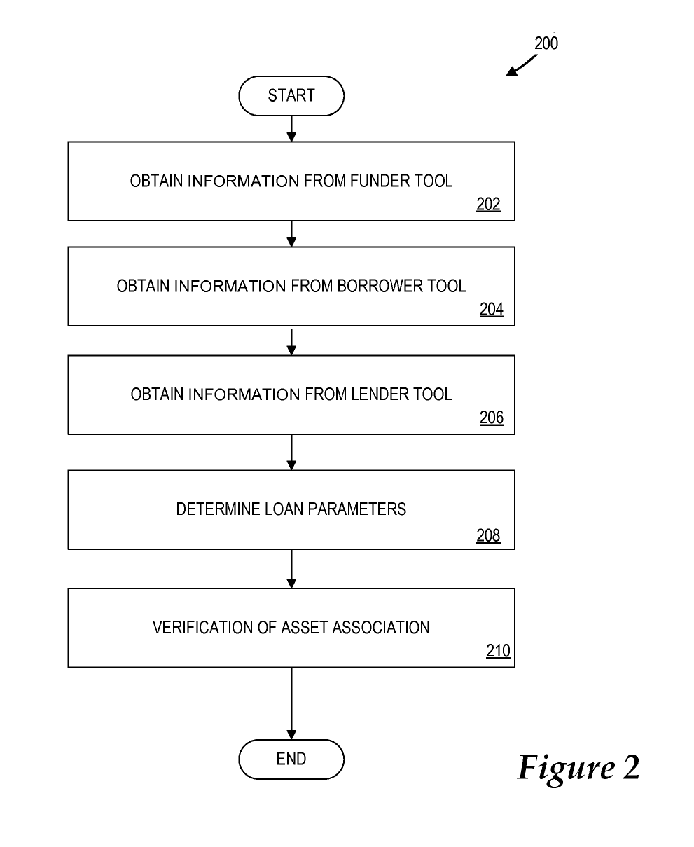

With reference to FIGS. 1 and 2, aspects of a control method 200 are described in conjunction with the above-described example. The control method 200 includes a process at block 202 where funding information is obtained by the Control Tool 120 via the Funder Tool 108. In the present example, the parent uses the Funder Tool 108 to enter information that enables other entities to identify and associate funds or other assets. In this part of the process, the information may include but is not limited to account information, transfer records, credit information, etc. As applied to the present example, the parent may identify their savings account held at a bank with a balance of $1,000. Mechanisms of the present invention allow the Control Tool 120 to associate these funds to a credit account of the Borrower without the need to transfer the funds. The parent might alternatively indicate through the Funding Tool that the parent intends to transfer $1,000 into an account created for the purpose of holding funds for the purpose of funding a loan from Lender to Borrower. In this case, the Control Tool 120 would associate any funds placed in this account with the credit account of Borrower without the need to pay any funds to Lender. The Control Tool 120 may also capture an agreement provided by the Funder to create a lien on the identified funds.

Shown at block 204, the daughter, the Borrower, uses the Borrower Tool 104 to enter information. The information entered at this phase may include, but is not limited to name, address, social security number or other government issued identification number, phone, email and other contact information and any other information that may be used to identify and evaluate the Borrower.

At block 206, the Control Tool 120 obtains and stores information provided by the Lender. In the present example, the Lender is a bank, and the bank provides the information via the Lender Tool 106. The information communicated at this phase may include lending terms and other parameters that define the conditions of their lending terms.

Next, at the Control Tool 120, block 208 describes a process where the control method 200 calculates a set of loan terms that is based on the obtained information obtained in blocks 202-206. This process may include the generation of a credit limit based on the loan terms provided by the Lender, the type and amount of the funds provided by the Funder, and the credit rating information of the Borrower. As applied to the above example, if the Funder provides $1,000 at block 202, and the Lender risk parameters are set to standard levels, the process of block 208 may determine that the Borrower may have up to $1,000 credit limit. The credit limit may also be at a lower or higher amount if more conservative or aggressive parameters are provided by the Lender. Although this example shows the process of block 206 to be at the Control Tool 120, it can be appreciated that the calculation at this stage can be conducted in any other location by the use of the data provided and coordinated by the Control Tool 120.

The Control Tool 120, shown in block 210, may include a mechanism to verify that Funder has taken the steps necessary to fund the loan activity between Lender and Borrower. Funder will used the Funder Tool 108 to identify the amount of funds to be associated and the manner of association. The Control Tool 120 may through the Funding Tool 108 permit the Funder to choose among a variety of association methodologies or may direct Funder to associate the funds using a prescribed method. Funder may associate the funds or other assets by paying the funds to Lender or to an affiliate, agent or representative of Lender. Funder may pay the funds to an escrow agent with instructions acceptable to Lender on the circumstances and manner under which the funds would be paid to Lender. Funder may retain the funds in an existing account and subject the funds in the account to a security interest acceptable to Lender. Funder may also pay the funds into an account created for this purpose and subjected to a security interest acceptable to Lender. Assets other than funds may also be used. The verification of payment, deposit and/or lien will be done by mechanisms known to someone ordinarily skilled in the art. In one example, the Control Tool 120 queries the database of the system of record for the Deposit Holder to (a) confirm that Funder has created the required deposit account, (b) confirm that Funder has deposited funds into the deposit account, (c) to verify the amount of funds deposited, or any combination thereof. It can be appreciated that the process of block 210 may involve communication to other sources to enable the credit or loan. Other alternative embodiments of process block 210 may include communication between the Control Tool 120 and the Lender Tool 106 where the Lender verifies that Funder has completed the funding.

As applied to the above example, the result of the above-described process is issuance of a credit card in the daughter's name secured by a deposit held by Deposit Holder in the Parent's name with funds being loaned by a third party Lender. This process bypasses the need for Funder to transfer funds into the daughter's name, which would ordinarily disrupt earned interest and/or tax strategy.

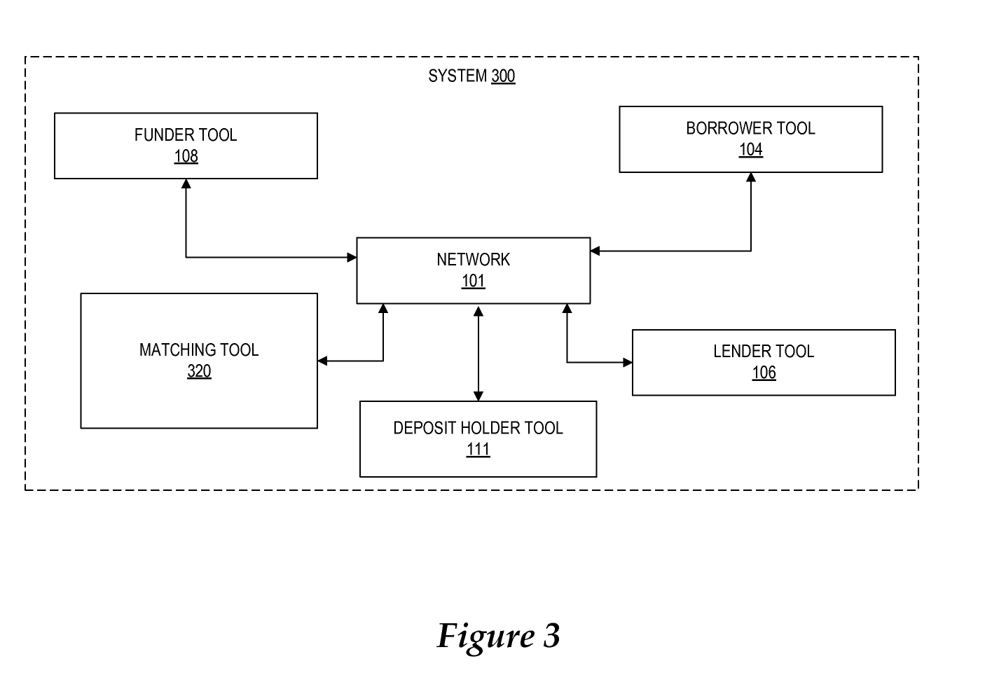

Turning now to FIG. 3, a description of computerized mechanisms for matching entities is provided. The computer mechanism for matching will permit matching in a number of ways. In one configuration, matching is based on mutual selection among entities. In this configuration, the matching is done through mutual selection of unique identifiers such as a name, email address, other person information, identification code assigned by system, etc. In another configuration, matching is based on criteria specified by one or more entities through their respective tools. In this configuration, entity specified criteria are used to match entities. Where matching of criteria results in a plurality of possible entity matches then other mechanisms are used to determine the match. In another configuration, matching is accomplished through a bid or auction process in which Funders, Borrowers and Lenders are permitted to provide the terms under which they are willing to participate either in terms of fee, interest rate or any combination of the above. The bid or auction process may be used alone or in conjunction with a filtering mechanism.

The components in FIG. 3, which include a Network 101, Borrower Tool 104, Funder Tool 108, Lender Tool 106 and the Deposit Holder Tool 111 function in a similar fashion to the like-named components described above. The Matching Tool 320 may also be configured with the functionality of the Control Tool 120 in conjunction with the matching functionality described below.

In one embodiment, the matching is based on mutual selection of unique identifiers. This matching process, which is also referred to herein as User Match, can be applied by the use of any unique identifiers associated with each entity. The unique identifiers may be supplied by the entities or be generated and assigned to entities by the matching process. As applied to the example described above involving the parent and daughter, the Matching Tool 320 offers the ability of the Funder to specify a unique identifier for Borrower through the Funder Tool and for Borrower to specify a unique identifier for Funder through the Borrower Tool 104. The Matching Tool 320 then makes the association of the Borrower and Funder whose unique identifiers were specified so the parties can execute the processes described herein. This feature can also be applied to include the identification of the other entities, such as the Lender and/or the Deposit Holder. As a non-limiting example, unique identifier may include an email address, social security number, uniquely generated number, etc.

In another embodiment, the matching process matches entities using criteria specified by the entities through their respective tools. In the case of Funder, these criteria may include without limitation loan product type, loan term, amount Funder will fund, Funder fee and minimum Borrower credit score. In the case of Lender, these criteria may include without limitation loan product type, loan term, interest rate and/or fees charged, minimum and maximum loan amount, minimum Borrower credit score, asset association mechanism, and requisite Funder attributes. In the case of Borrower, these criteria may include without limitation loan product type, loan term, requested loan amount, interest rate or fees charged by Lender, interest rate or fees charged by Funder, fees charged by Deposit Holder, interest paid by Deposit Holder, and minimum duration for commitment of funds by Funder. In the case of Deposit Holder, these criteria may include without limitation minimum and/or maximum deposit amount, the interest Deposit Holder will pay and the fees that Deposit Holder will charge. These criteria will be processed and compared in order to determine whether an entity's criteria match the criteria specified by another entity. In the event there is a match with only one other entity then those entities will be matched by the Matching Tool and notified of the result through their respective tools. In the event there is a match with multiple entities then a mechanism will be employed to select one from among that group. One configuration of the invention will use a filtering and selection mechanism to select from that group. Using this mechanism the selecting entity will be presented with a list of all entities that satisfy its criteria and will select from among them by designating a single entity through the selecting entity's tool. For example, the invention may apply a filter of potential Borrowers based on Funder selected criteria for Borrower's FICO score, other credit history data, geographical location, and other factors. Funder would be simultaneously filtered to ensure that only those Borrowers who are looking for a loan product offered by Funder, for example, are considered. The Borrowers who meet Funder's requirements would be presented as candidates and Funder would select one or more with which to be matched.

The Matching Tool 320 can also be configured to assign borrowers to a category using methods known to one of ordinary skill in the art including but are not limited to using user data including but not limited to credit bureau data, credit score, geographic, demographic, marketing channel, time of day and other user response data to predict performance including but not limited to future profitability, default, delinquency, payment, usage or attrition behavior. The predictive and categorization methods include but are not limited to logistic regression, multi-variate regression, rule based, neural net, linear programming and other modeling methods.

In another configuration, the Matching Tool 320 selects a match that would optimize financial results or other aspects of the funding or borrowing relationship based on priorities specified by the entities through their respective tools or based on other optimization parameters. The invention can be applied to match any combination or number of entity types. Thus, for example, the invention can match all four entities, Lender, Borrower, Funder and Deposit Holder. It can also be appreciated that the Lender and the Deposit Holder can be the same entity.

In another embodiment, the matching function includes, either independently or in conjunction with one or more of the other matching processes, a bid or auction process in which one or more group of Funders, Borrowers, Lenders and/or Deposit Holders are provided with the opportunity to input through their respective tools the fees and/or other terms under which they are willing to participate in a specified transaction. The selecting entity may specify the priority that will be assigned to terms. For example, the selecting entity may indicate that the fee charged will be the most important factor in evaluating the bids. Processing of the various terms obtained from each entity enables the system 100 to generate lists with preferred candidates for the selecting entity to select from based on the priorities assigned by the selecting entity. The entities participating in the bid or auction process may be given the opportunity to adjust their bids and/or may be given visibility into the bids made by the entities with which they are competing.

For illustrative purposes, non-limiting matching examples are provided. In this example, Jacquelyn, Funder 1, decides she wants to invest some money. Jacquelyn enters terms in the Funder Tool 108. In her designated terms, she indicates that she is interested in funding two credit card lines, Loan A and Loan B, at an amount up to $300 each. She selects the Category Match for the means of being associated with the loans. For Loan A she sets her Loan Terms as $7/month fee for people in Category Score, Good. For Loan B sets her Loan Terms as $5/month fee for people in Category Score, Very Good. As can be appreciate by those skilled in the art, the categories can be associated with a variety of ways to and also backed by other credit scoring criteria.

In this example, Alison is a second funder, Funder 2. Alison enters her terms in the Funder Tool 108. Alison's data indicates that she is interested in funding one credit card at an amount up to $400. Alison has more experience with lending so wants to set more detailed Lender Terms. She selects User Match and sets her Loan Terms as $5/month fee for any individual who has a FICO score equal or greater than 680 and other outstanding credit card balances of less than $10,000.

Also part of the current example, Bank A is the Lender. The Lender has provided data with parameters into the Lender Tool 106 indicating the Lender is willing to issue a credit card with a servicing fee of $3/month and is willing to lend a credit limit of a credit card that is 100% secured by a lien on a deposit. In this example, Bank A may input data indicating it will set the credit limit at $200 if a funder provides a deposit amount of $200.

Casey, a Borrower, enters information in the Borrower Tool 104. The data provided by Casey indicates that the Borrower is willing to accept any credit card with a limit between $200 and $500. The data also indicates the Borrower is willing to pay a fee up to $10/month. The system 100 may also be configured to allow the borrower to enter a social security number and other identifiable information.

The Matching Tool 320 is configured to use Casey's information to obtain her FICO score and other bureau information. In this example, a custom scoring model based on the history of other similar applicants, current economic conditions, and predicted future conditions calculates Casey's Category Score as equal to “Very Good.” The credit bureau data shows Casey's FICO score to be 680 and other outstanding card balances of $7,000.

Using techniques of the invention, the Matching Tool 320 matches Casey to Jacquelyn's Loan B. The Loan Terms are $300 credit limit with a monthly fee of $8.50/month. The $8.50 is comprised of $5 for Jacquelyn, $3 for Bank A and a $0.50 service fee to the entity associated with the Matching Tool 320.

The present invention is configured to have modifiable matching criteria to conform to different desired outcomes. In the above-example, for instance, the Matching Tool 320 is configured to minimize Borrower fees. Thus, Casey was matched with Jacquelyn's Loan B. However, if the Matching Tool 320 is configured to maximize Funder fees, it would match Casey to Jacquelyn's Loan A. Alternatively, if the embodiment is configured to maximize Borrower credit limit, the Matching Tool 320 would match Casey to Alison's $400 credit limit card versus Jacquelyn's $300 credit limit card.

Additional variations of matching criteria can be based on additional Lenders. For instance, the embodiments described above may have included an additional Lender charging a serving fee of $4/month but willing to lend 110% of the a secured deposit amount for Borrowers with a FICO score of 680 and $2/month at 80% of the secured deposit amount. The Matching Tool 320 would then vary matching based on monthly fees and available credit. The Matching Tool 320 can also manage the variations of the matching criteria if additional Borrowers are included.

In the above example, the Matching Tool 320 identifies a match between Lender, Borrower and Funder based on optimization assumptions. In another variation, the Matching Tool 320 may provide the Lenders, Borrowers or Funders options that meet their criteria for the entities selection based on filtering criteria. For example, Casey may have been presented all three loan options from which she could choose. Or the Lender may have been presented with the three loan options from which it was willing to offer Casey. In this embodiment, auctioning techniques can be used to help the entities select other matches based on a list of desirable candidates. Alternative embodiments allow direct user matching by the use of identifiers, such as an email address or tax ID. In such an embodiment, Casey could specifically select Alison and each entity could communicate through the Matching Tool 320 to identify one another and facilitate the Funder-Borrower relationship.

In yet another embodiment, the invention provides mechanisms for managing relationships between Funders, Lenders, Borrowers or any combination of these and other entities. With reference to FIG. 3, aspects of one embodiment of a Management System 400 are described. The Management System 400 includes a Network 101, Borrower Tool 104, Funder Tool 108, Lender Tool 106 and Deposit Holder Tool 111, each of which function in a similar fashion to the like-named components described above. A Management Tool 420 is configured to manage the relationships between the entities, as described below. The Management Tool 420 may also be configured with the functionality of the Control Tool 120 and the Matching Tool 320.

Funder information, Lender information and Borrower information are stored in a database. As described above with respect to block 208 of FIG. 2, processes of the present invention utilize predetermined or calculated parameters to formulate loan terms. The results of the formulation are submitted to the Management Tool 420, which ensures borrower usage is managed within the loan terms. The Management System 400 may process and store information related to borrower usage. The Management Tool 420 may obtain information related to borrower usage from an external processing system. The Management Tool 420 tracks and reports borrower usage information. The Management Tool 420 may also track and report on information related to the associated asset. Funder and Lender may through the Funder Tool and Lender Tool program or input a request for the Management Tool 420 to obtain information about Borrower and/or Funder such as credit bureau data or credit score. Based on the information obtained and processed by the Management Tool 420, Funder, Borrower, Lender and/or Deposit Holder may adjust the terms of their relationship with the other parties as permitted by the Management Tool and the agreements among the parties. The Management Tool may be configured to allow these adjustment to be made through their respective tools or to make adjustments without additional intervention based on parameters programmed through the respective tools. The Management Tool 420 may also be configured to terminate relationships and/or identify the need for new entity matching.

In one example, a father puts $300 into deposit account to fund the issue of a credit card by the bank holding the deposit or another entity to his daughter. The father retains ownership of funds, earns any interest on the funds and does not expose himself to any credit risk. The deposit account is subject to an account control agreement in favor of the Lender to secure all of the daughter's obligations under its credit card arrangement with the Lender. Processing of the Lender parameters result in the issuance of a credit card with $300 credit limit to the daughter. The relationship is now created. The management embodiment of this invention manages the relationship between the Funder (father), Borrower (daughter), Lender (credit card issuer) and, in cases where different from Lender, the Deposit Holder.

The management functions collect and disseminate information about Borrower usage to Funder and Lender, can be programmed to adjust Funder and/or Lender terms based on Borrower usage or other events, can be adjusted by Funder and/or Lender as they deem appropriate from time to time and can facilitate the termination of the relationships and identify the need for new entity matching.

For example, in the example above the daughter has a credit limit of $300 on her credit card. The daughter uses the credit card to purchase products at retail stores. This credit card activity is processed and recorded in a database maintained by a credit card processor and delivered to the management system where it is then reported to the Lender. The delivery of the data and reporting of the data to Lender are done by methods known to those ordinarily skilled in the art.

The daughter uses her credit card and makes payments on the card in a timely manner for 6 months. Lender has input criteria through the Lender Tool 106 and stored in the database that after 6 months of timely payments the credit limit for the card user is to be increased to 110% of the Funder deposit amount. The management tool is configured to track the regularity of payments and after 6 months of on time payments it processes the Lender instruction to increase the daughter's credit limit to $330, notifies the credit card processing system of this increase and notifies the daughter and father of the increase.

After 9 months the daughter's behavior changes. She is late on 2 consecutive payments. Instructions set through the Lender Tool 106 cause the Management Tool 420 to lower the credit limit to 50% of the deposit amount or $150, notify the credit card processing system and notify the daughter and father of the credit limit adjustment.

By the features provided by the present invention, the father can notice the change in the credit limit. Then, by the use of a computerized method conformed in accordance with the invention, the father can manually initiate a request to reduce the amount in the deposit account from $300 to $200 through the Funder Tool. The management system notes the request and causes a reduction of the credit limit to $100 or 50% of the requested $200 deposit amount. The management system identifies whether the current balance on the card is below or above the new $100 credit limit. If the current balance is above $100, the management system notifies the father that the deposit may not be decreased to the desired level due to the current credit card balance. If and when the outstanding balance, including all pending and authorized transactions, drops below $100 then the management system notifies the father that the deposit can be decreased and the funds will be available for withdrawal in the time frame for making withdrawals based on the account agreement with the Deposit Holder.

In the current example, after a year, the father decides to withdraw all of the funds in the account. The Management Tool 420 is configured to manage such requests. The Management Tool 420 may also be configured to handle messaging to the Borrower. In the example, upon the processing of the father's request to withdraw the funds, the daughter is notified that her credit card will be cancelled unless she can secure a new Funder. The daughter may be matched to a new Funder through any of the matching techniques described above.

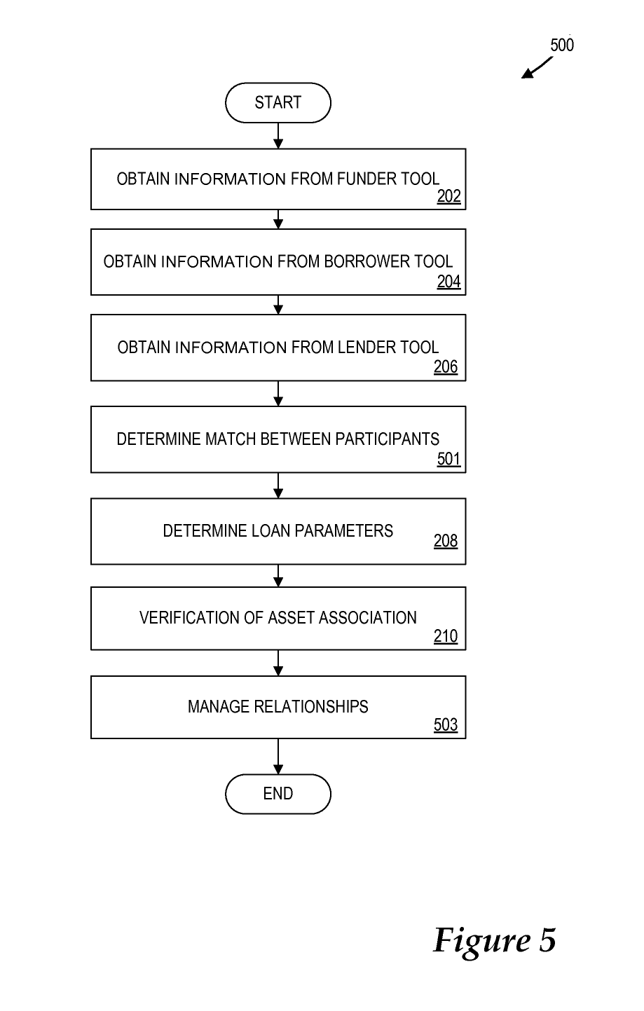

FIG. 5 introduces an example of how various features of the present invention can be combined. In this non-limiting example, a method 500 includes communication and control features, matching features, and management features. This diagram is to provide a non-limiting example of one combination of processes. As can be appreciated by one of ordinary skill in the art, and as illustrated above, implementations of the method may include fewer or more of the described features and each block can be re-ordered in a variety of ways.

As shown, the method 500 includes processes for obtaining data from a Funder Tool 202, obtaining data from a Borrower Tool 204 and obtaining data from a Lender Tool 206. The functionality of these process blocks are similar to the like-named components described above. Data is obtained from the various entity interfaces in blocks 202-206. As shown in block 501, the method 500 includes a matching process where at least two entities are matched in accordance to the data obtained in blocks 202-206. The process of block 501 can include any of the embodiments that match two or more entities. Next, as described above, block 208 includes a process for determining loan parameters; and a verification process 210 for verifying that an asset has been associated with banking activity between a lender and a borrower. Next, at block 503, the method 500 includes a process of managing the relationships between the matched entities. As described above, the process of block 503 may include adjustments to loan terms based on usage data or any other obtained data. As indicated the participating entities may also include a Deposit Holder and the processes would include obtaining data from a Deposit Holder Tool 111.

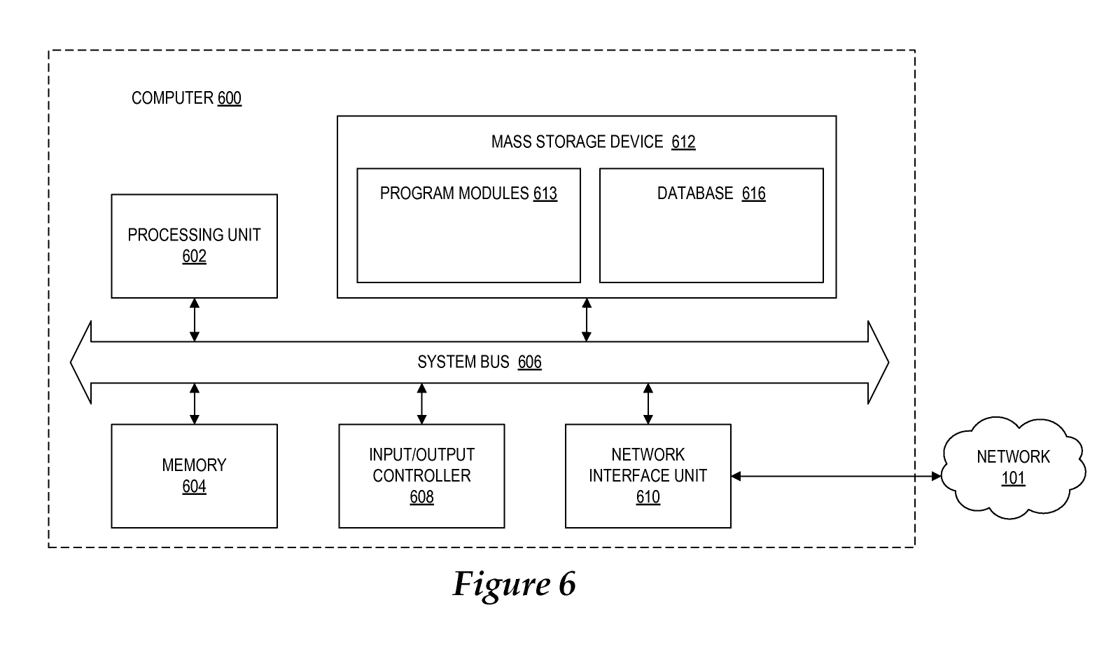

Turning now to FIG. 6, an example computer architecture diagram showing a computer 600 is illustrated. The computer 600 may include a central processing unit 602, a system memory 604, and a system bus 606 that couples the memory 604. The computer 600 may further include a mass storage device 612 for storing one or more program modules 613 of the invention and a database 616. Examples of the program modules 613 may include the functionality of the Borrower Tool 104, Funder Tool 108, a Lender Tool 106, and a Control Tool 113. In the same computer 600, or in other networked computers, the program modules may include the functionality of the Matching Tool 320 and/or the Management System 420.

The mass storage device 612 may be connected to the processing unit 602 through a mass storage controller (not shown) connected to the bus 606. The mass storage device 612 and its associated computer-storage media may provide non-volatile storage for the computer 600. Although the description of computer-storage media contained herein refers to a mass storage device, such as a hard disk or CD-ROM drive, it should be appreciated by those skilled in the art that computer-storage media can be any available computer storage media that can be accessed by the computer 600.

By way of example, and not limitation, computer-storage media may include volatile and non-volatile, removable and non-removable media implemented in any method or technology for the non-transitory storage of information such as computer-storage instructions, data structures, program modules, or other data. For example, computer-storage media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 600.

According to various embodiments, the computer 600 may operate in a networked environment using logical connections to remote computers through a network such as the network 108. The computer 600 may connect to the network 108 through a network interface unit 610 connected to the bus 606. It should be appreciated that the network interface unit 610 may also be utilized to connect to other types of networks and remote computer systems. The computer 600 may also include an input/output controller 608 for receiving and processing input from a number of input devices, including a keyboard, a mouse, a microphone, and a game controller. Similarly, the input/output controller 608 may provide output to a display or other type of output device.

The bus 606 may enable the processing unit 602 to read code and/or data to/from the mass storage device 612 or other computer-storage media. The computer-storage media may represent apparatus in the form of storage elements that are implemented using any suitable technology, including but not limited to semiconductors, magnetic materials, optics, or the like. The computer-storage media may represent memory components, whether characterized as RAM, ROM, flash, or other types of technology. The computer-storage media may also represent secondary storage, whether implemented as hard drives or otherwise. Hard drive implementations may be characterized as solid state, or may include rotating media storing magnetically-encoded information.

The program modules 613 may include software instructions that, when loaded into the processing unit 602 and executed, cause the computer 600 to provide communication and coordination between web services in a cloud-based computing environment. The program modules 613 may also provide various tools or techniques by which the computer 600 may participate within the overall systems or operating environments using the components, flows, and data structures discussed throughout this description. For example, the program modules 613 may implement interfaces for providing communication and coordination between web services in a cloud-based computing environment.

In general, the program modules 613 may, when loaded into the processing unit 602 and executed, transform the processing unit 602 and the overall computer 600 from a general-purpose computing system into a special-purpose computing system customized to provide communication and coordination between web services in a cloud-based computing environment. The processing unit 602 may be constructed from any number of transistors or other discrete circuit elements, which may individually or collectively assume any number of states. More specifically, the processing unit 602 may operate as a finite-state machine, in response to executable instructions contained within the program modules 613. These computer-executable instructions may transform the processing unit 602 by specifying how the processing unit 602 transitions between states, thereby transforming the transistors or other discrete hardware elements constituting the processing unit 602.

Encoding the program modules 613 may also transform the physical structure of the computer-storage media. The specific transformation of physical structure may depend on various factors, in different implementations of this description. Examples of such factors may include, but are not limited to, the technology used to implement the computer-storage media, whether the computer-storage media are characterized as primary or secondary storage, and the like. For example, if the computer-storage media are implemented as semiconductor-based memory, the program modules 613 may transform the physical state of the semiconductor memory, when the software is encoded therein. For example, the program modules 613 may transform the state of transistors, capacitors, or other discrete circuit elements constituting the semiconductor memory.

As another example, the computer-storage media may be implemented using magnetic or optical technology. In such implementations, the program modules 613 may transform the physical state of magnetic or optical media, when the software is encoded therein. These transformations may include altering the magnetic characteristics of particular locations within given magnetic media. These transformations may also include altering the physical features or characteristics of particular locations within given optical media, to change the optical characteristics of those locations. Other transformations of physical media are possible without departing from the scope of the present description, with the foregoing examples provided only to facilitate this discussion.

Based on the foregoing, it should be appreciated that technologies for providing communication and coordination between web services in a cloud-based computing environment are presented herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A computer-implemented method, wherein the method associates an asset of a first participant to facilitate lending activity between a second participant and a third participant, the method comprising computer-implemented operations for:
obtaining funder data from a funder tool 108, said funder data associated with said first participant;
obtaining borrower data from a borrower tool 104, said borrower data associated with said second participant;
obtaining lender data, said lender data associated with said third participant; and
processing funder data, borrower data, and lender data to determine a set of parameters that define loan terms between said second participant and said third participant, wherein a value of the asset influences at least one of the loan terms.

2. The computer-implemented method of claim 1, wherein obtaining lender data includes receiving the lender data from a lender tool 106.

3. The computer-implemented method of claim 1, wherein processing further comprises generating agreements that are based on the parameters.

4. The computer-implemented method of claim 1, wherein the processing includes identity verification of one or more participants.

5. The computer-implemented method of claim 1, wherein the processing includes obtaining rating data that characterizes a credit rating of one or more of the participants and using the rating data for determining of the set of parameters that define the loan terms.

6. The computer-implemented method of claim 1, wherein the processing further comprises:
defining terms under which the asset is associated with the lending activity between said second participant and third participant;
verifying that the asset has been associated in accordance with the defined terms; and
generating a notification for receipt by third participant indicating verification.

7. The computer-implemented method of claim 6, wherein the terms under which the asset is associated includes a requirement that the asset is in an account and subject to a perfected security interest.

8. The computer-implemented method of claim 6, wherein the terms under which the asset is associated include a requirement that the asset is possessed by an intermediary subject to a three-party agreement regarding the circumstances and manner under which all or any portion of the asset would be delivered to the third participant or returned to the first participant.

9. A computer-implemented method, wherein the method associates an asset of a first participant to facilitate lending activity between a second participant and a third participant, the method comprising computer-implemented operations for:
obtaining funder data from a funder tool 108, said funder data associated with said first participant;
obtaining borrower data from a borrower tool 104, said borrower data associated with said second participant;
obtaining lender data, said lender data associated with said third participant; and
processing funder data, borrower data, and lender data to determine a match between two or more participants;
processing funder data, borrower data, and lender data to determine a set of parameters that define loan terms between said second participant and said third participant, wherein a value of the asset influences at least one of the loan terms.

10. The computer-implemented method of claim 9, wherein the processing includes an optimization technique to optimize the financial return or other elements of the lending, funding or borrowing relationship for one or more of the participants.

11. The computer-implemented method of claim 9, wherein the matching includes a simultaneous match of all participants.

12. The computer-implemented method of claim 9, wherein the method further comprises:
obtaining deposit holder data that describes terms associated with a deposit holder; and
matching the deposit holder with at least one participant.

13. The computer-implemented method of claim 9, wherein that match includes:
generating a candidate list of multiple participants according to matching criteria; and
generating a displayable data set containing the candidate list.

14. A computer-implemented method, wherein the method associates an asset of a first participant to facilitate lending activity between a second participant and a third participant, the method comprising computer-implemented operations for:
obtaining funder data from a funder tool 108, said funder data associated with said first participant;
obtaining borrower data from a borrower tool 104, said borrower data associated with said second participant;
obtaining lender data, said lender data associated with said third participant;
processing funder data, borrower data, and lender data to determine a set of parameters that define loan terms between said second participant and said third participant, wherein a value of the asset influences at least one of the loan terms; and
managing the set of parameters that define loan terms, wherein the set of parameters are adjusted depending on a set of usage data.

15. The computer-implemented method of claim 14, wherein the set of parameters that define loan terms include a credit limit, and wherein managing the set of parameters includes changing the credit limit based on the usage data.

16. The computer-implemented method of claim 14, wherein the set of parameters that define loan terms includes interest rates and fees, and wherein the usage data includes repayment data, and wherein managing the set of parameters includes changing the interest rate or fees based on the repayment data.

17. The computer-implemented method of claim 14, wherein the set of parameters that define loan terms includes data representing a loan period, and wherein managing the set of parameters includes changing the loan period based on the usage data.

18. The computer-implemented method of claim 14, wherein the set of parameters that define loan terms include a credit limit, wherein the set of parameters that define loan terms include data indicating the value of the asset, and wherein managing the set of parameters includes processing data indicating the value of the asset and adjusting the credit limit depending on changes to the data indicating the value of the asset.

19. The computer-implemented method of claim 14, wherein managing the set of parameters that define loan terms includes:
determining the presence of data that indicates a need to terminate the lending activity; and
generating communication to indicate the termination of the lending activity.

20. The computer-implemented method of claim 19, wherein managing the set of parameters includes the generation of a new set of parameters that establishes a new match with at least one substitute participant.
